(19) United States
(12) Patent Application Publication
(10) Pub. No.: US 2005/0060751 A1
(43) Pub. Date: Mar. 17, 2005

(54) Method and system for audience participation and selective viewing of various aspects of a theatrical performance, whether opera, symphonic, drama or dance or combinations and variations thereof

(76) Inventor: Donald A. Glaser, Berkeley, CA (US)

Correspondence Address: Donald A. Glaser, 41 Hill Road, Berkeley, CA, 94708, US

(21) Appl. No.: 10/920,704

(22) Filed: Aug. 17, 2004

Related U.S. Application Data
(63) Continuation of application No. 09/695,548, filed on Oct. 23, 2000, now abandoned.
(60) Provisional application No. 60/163,893, filed on Nov. 5, 1999.

(51) Int. Cl. G06F 17/00

(52) U.S. Cl. 725/87

(57) ABSTRACT

The present invention provides a solution to the problem of providing a cost effective means of enhancing the pleasure of an attendee at a musical or dramatic or other type of public performance, or at a large classroom or other teaching venue, through a system and method for collecting video images and text at a performance, transmitting these data to authorized individual viewing devices in an attendee's possession at the performance venue, the attendee being able to select the video image desired or text or a combination of both for viewing at the attendee's location.

### CROSS-REFERENCE TO RELATED APPLICATIONS

This application claims the benefit of U.S. Provisional Application No. 60/ 163,893 filed Nov. 5, 1999, which is incorporated fully herein by reference.

### TECHNICAL FIELD

This invention relates to the field of communications systems. More particularly, the present invention relates to a method and system for controllably viewing video images of a performance and/or text related thereto.

### BACKGROUND ART

It has been observed by symphony and opera conductors, directors and general managers, that audiences are shrinking for classical music and opera partly because younger people are not joining the audiences in as large numbers as they previously did. College professors teaching very large classes have similarly worried about helping younger students to be more attentive in such large venues.

Various methods have been implemented in the past to improve attendance at such functions. In opera houses, supertitles are generally now used, wherein the language of the opera (such as German for example) is translated into the language of the audience; that is, into English in the US or the United Kingdom; into French in France; into Spanish in Spain; etc. This has improved the experience for those not fluent in the language of the performance. Similarly, Opera houses and Symphony Orchestras have invited the public to selected rehearsals and to pre-performance background discussions of the works to be performed, or of the authors of the works, or discussions of the mechanical aspects of the production itself.

Another method of addressing the general problem of improving the personal involvement of attendees at large venues, such as symphonies, operas or even large college classrooms, has involved the use of large video screens, either hanging large TV screens from the ceiling so that a thousand students, huddled in groups under the screens, can see the distant professor and blackboard; a very dismal way to be educated, or by having large TV screens strategically placed around the symphony or opera venue so that attendees a distance away from the stage can have a feeling of participation in the event.

However, none of these devices has addressed the interests per se of younger people. In an attempt to address this problem, it is thought that younger people might enjoy classical music more if they understood it better and if the performance had some elements of a ‘participation sport’. Similarly, it is thought that being able to provide supertitles in several languages, selectable by the attendee, would enhance attendance by many more in our multi-ethnic societies. This participative effort would require a screen for each attendee, since economics appears to dictate having very large classes and large symphony halls and Opera auditoria.

A technical problem presently exists in the attempt to provide such an individual viewing device for each attendee in that the cost of such a device must be minimal, the means for transmitting must be flexible and cost effective, and the media transmitted and displayed must be adaptive to the concerns and desires of the individual attendee without impinging on the rights of and enjoyment of the neighboring attendees.

The use of a standard personal computer laptop, such as the Apple™ iBook™ is overkill and too costly as a viewing device for the solution to this problem. In a preferred solution, a system would be needed having a low power TV transmitter, effective only within the concert/performance hall, together with a simplified flat panel TV receiver device, of size somewhere between a cell phone display and a laptop computer display, having some ability to get audience feedback without wiring. Each channel of information could use a different pretuned carrier frequency.

These is a need in the art for a system and method for cost effectively capturing the video images of performers and lecturers in a performance venue, for transmitting such video images and related textual data to attendees at the performance, whereby the attendees can selectively view at their seat, different video images, text (musical scores, supertitles in several languages, and other related text) or a combination of both, in order to enhance the experience of attending the performance.

### SUMMARY OF THE INVENTION

The present invention provides a solution to the needs described above through a system and method for collecting video images and text at a performance, transmitting these data to authorized individual viewing devices in an attendees possession at the performance venue, the attendee being able to select the video image desired or text or a combination of both for viewing at the attendees location.

A system is disclosed for permitting attendees at a public performance to selectively view video, text or a combination of both by use of a viewing device. The system contains one or more video cameras for inputting video images of performers such as musicians, conductors, singers, dancers and lecturers/speakers; contains one or more input devices for inputting text data into the system; contains a central control device for receiving the video and text data, for storing these data and for transmitting these data via a short range transmission system, whereby one or more attendees through the use of individual viewing devices can selectively view a video image of a performer, related text of a combination of both at the attendees seat

Also disclosed is an apparatus for viewing video, text or a combination of both by an attendee at a symphony, opera, classroom lecture or other public performance, the apparatus having a display, memory, processing unit, control panel, and a control program in the processing unit memory adaptable to receive short range wireless transmissions of video data, text data or both, and to display selective images as chosen by the attendee.

A method is disclosed for enhancing the enjoyment of attendees at a public performance which includes: obtaining an attendee viewing device; turning on the viewing device to have it registered with a viewing system located in the venue of the performance; and selecting on the viewing device a video image of a performer or text or a combination of both, the video images and text being transmitted in a wireless mode by the viewing system and received by the attendee viewing device. Still other embodiments of the present invention will become apparent to those skilled in the art from the following detailed description, wherein is shown and described only the embodiments of the invention by way of illustration of the best modes contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

The features and advantages of the system and method of the present invention will be apparent from the following description in which:

FIG. 1 illustrates an exemplary symphony stage configuration.

FIG. 2 illustrates a representative system containing elements of a preferred embodiment of the invention.

FIG. 3 illustrates an exemplary attendee viewing device.

FIG. 4 illustrates a block diagram of the preferred embodiment of the process of using the attendee viewing device in the preferred embodiment.

FIG. 5 illustrates a block diagram of the operation of the system in the preferred embodiment.

### DETAILED DESCRIPTION OF THE INVENTION

The present invention provides a solution to the problem of providing a cost effective means of enhancing the pleasure of an attendee at a musical or dramatic or other type of public performance, through a system and method for collecting video images and text at a performance, transmitting these data to authorized individual viewing devices in an attendee's possession at the performance venue, the attendee being able to select the video image desired or text or a combination of both for viewing at the attendee's location.

Operating Environment

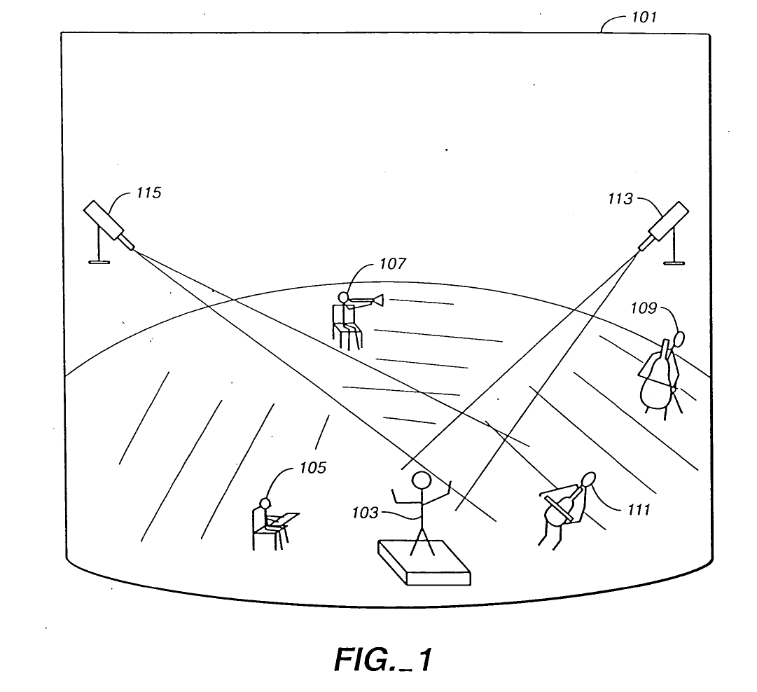

The environment in which the present invention is used is now described with reference to FIG. 1

In FIG. 1, a typical performance stage is shown depicting for example, an orchestral stage setting. Similar settings in other performances would include an opera production wherein the performers on the stage are singers and dramatists, while the musicians are located in the orchestra pit (not shown); or a drama wherein the performers onstage are actors and no musicians are involved; or the performance could be a ballet or other dance performance wherein the performers on stage would be dancers and again the musicians would be in the pit; and finally the performer could be a lecturer or speaker in a classroom setting or on a similar performance stage. In each of these performance settings the basic aspects and concepts of the invention are the same.

In FIG. 1, a stage 101 is shown containing various performers; a conductor 103, a first violin 105, a cellist 111, a bass 109 and a brass (trombone) player 107. One or more inexpensive video cameras are either mounted in a fixed position as shown 113, 115 or could he hand held devices. These cameras would generally focus on the conductor 103 or on one of the principal players 105, 111, etc. These performers could be singers in an opera, dancers, etc. In this type of setting the video images would generally be carried or transmitted to a control video receiver/processor/controller for retransmission to selected receivers and/or to video recorders. The retransmission would generally be by wireless means.

### THE INVENTION

In the preferred embodiment of the invention each attendee in an auditorium could be provided with an inexpensive wireless viewing device which could be used unobtrusively without interfering with the person sitting in an adjacent seat. Without the expense of wiring each seat, the viewer would have a touchpad with a few buttons that allow him/her to choose to view the musical score as the piece is played, or see opera supertitles in one of several languages, or a close-up view of the French horn section whenever it has the solo part, or the trumpets, or the cellos etc. The viewer could also choose to watch the conductor's sweating face. This strategy is one commonly used during TV shows of symphony music. Television cameramen trained to focus the telephoto lens on the currently important part of the orchestra are very skillful at this. Thus the audience can have a sense of sitting in the midst of the orchestra or opera stage, of following the score and/or libretto, and of seeing in detail what is happening ‘where the action is’.

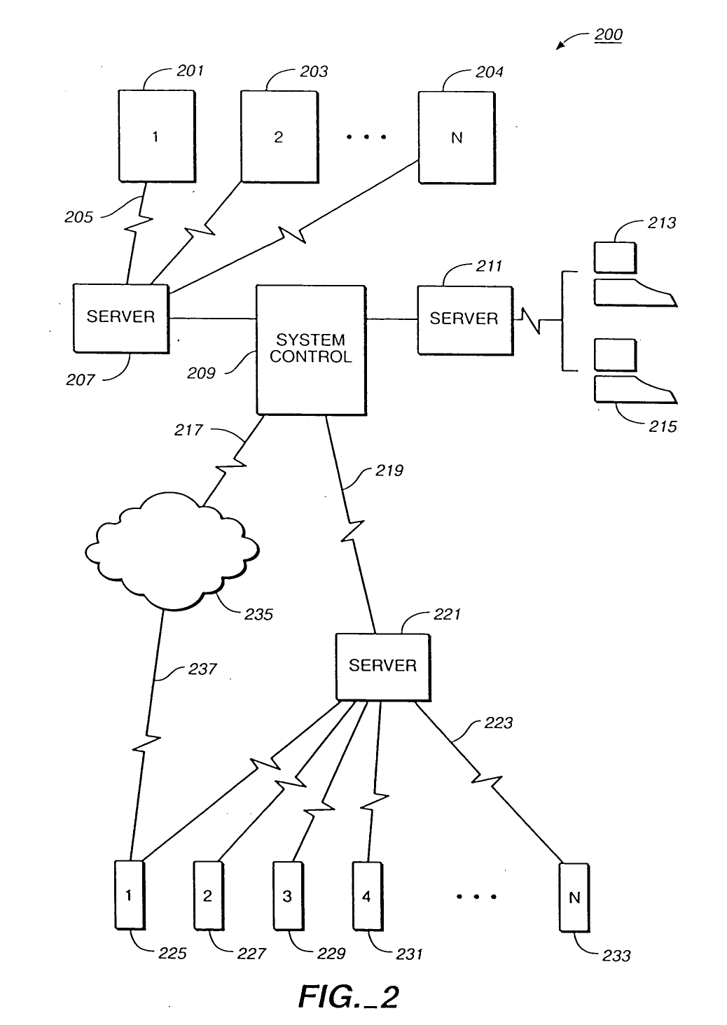

Referring now to FIG. 2, an exemplary system describing a preferred embodiment is described. In the system, a number of video cameras 201, 203, 204 are shown connected to a server device 207 which itself is connected to or a part of a system control device 209. Also connected to the system control device 209 could be another server 211 (which itself may or may not be a part of server 207) to which are connected one or more text input terminals or scanners 213, 215. The text input terminals or scanners would be used for inputting musical scores, opera text in various languages, diagrams, etc. Also connected to the system control device 209 would be another server 221 which would receive “log-on” messages from attendee viewing devices 225, 227,229, 231, 233 As will be explained in more detail below, the attendee viewing device would transmit a “log-on” message whenever the attendee turned the device on. The log-on message to the server 221 provides the information for the particular device such as id number, information on how another part of the system can talk to the attendee device (perhaps device driver information), which frequencies it operates with, etc., basic characteristics of the viewing device. The server 221 provides the information required to communicate with the viewing devices to the system control unit 209 so that after log-on by a viewing device, the system control 209 con transmit video and text directly 217, 235, 237 to a viewing device 225. It is contemplated that the system control device 209 would transmit all video and text data in a broadcast mode 217, 235 using different frequencies for each video camera and text channel, and an individual attendee viewing device 225 would receive 237 only the video or text data on the channel/frequency he selects by use of the selector buttons on the viewing device.

In an alternative embodiment, a simpler system would consist of a TV transmitter broadcasting all channels simultaneously, the channel selection to be done by the viewer as in a conventional TV receiver. More complex server technology is needed if it is desired to keep track of how attendees are using the system.

In a preferred embodiment of the invention it is expected that the attendee viewing devices would be devices having a Sun Microsystems Inc.™ Java™ operating system and a JINI™ capable system therein, with the server 221 being a JINI server. The entire system could be a Java/JINI based system with the video cameras 201, 203, 204 and the text input devices 213 215 and their related servers 207, 211 also being JINI compatible devices. Java and JINI are program systems provided by Sun Microsystems, Inc. and are well known to those skilled in these arts. JINI is described in more detail in the document titled “Jini(TM) Device Architecture Specification” which can be found at the Sun Microsystems web site www.sun.com/jini/whitepapers/ and which is incorporated fully herein by reference.

Alternative embodiments can include other plug-and-participate devices such as those provided by other network technologies complimentary to JINI, such as Bluetooth™, JetSend™ and HAVI™.

Bluetooth is a technology specification for low-cost, short range radio links among PDAs, laptops, mobile phones, and other portable devices. When two Bluetooth devices come close to each other, they automatically detect each other and establish a network connection. This is a network transport protocol that could be used to allow attendee viewing devices to be connected to a JINI compatible system without being physically connected. Bluetooth is being developed by IBM Corporation™, Intel Corporation™, Nokia Corporation™, Telephon AB™, L. M. Ericsson™ and Toshiba Corporation™.

Other technologies like Motorola's™ Piano, which can be built on top of Bluetooth, specifies what sort of information they exchange and how they communicate. It and other operating systems, like Symbian Ltd.s™ Epoc32 for cell phones, can support JINI technology.

Hewlett Packard's™ JetSend technology is another example of a service protocol that allows devices to intelligently negotiate information exchange. Similarly HAVI (Home Audio-Video interoperability) is a specification for home networks of consumer electronic devices such as CD players, televisions, VCRs, digital cameras etc. HAVI is an example of where a bridge protocol would be needed to share information between HAVI compatible devices and a JINI compatible system. HAVI is being developed by Grundig A. G.™, Hitachi Ltd.™, Matsushita Electric Industrial Co. Ltd.™, Phillips Electronics N.V.™, Sharp Corporation™, Sony Corporation™, Thompson Multimedia S. A.™, and Toshiba Corporation™.

Still another embodiment can make use of newly announced “Zipper-VDSL” technology from STMicroelectronics™ and Swedish Telecom operator Telia™, which is based on a new generation of silicon chips that are inexpensive to produce and capable of delivering full-motion video over ordinary phone lines at speeds 10 times faster than ADSL (asynchronous digital subscriber line) technology.

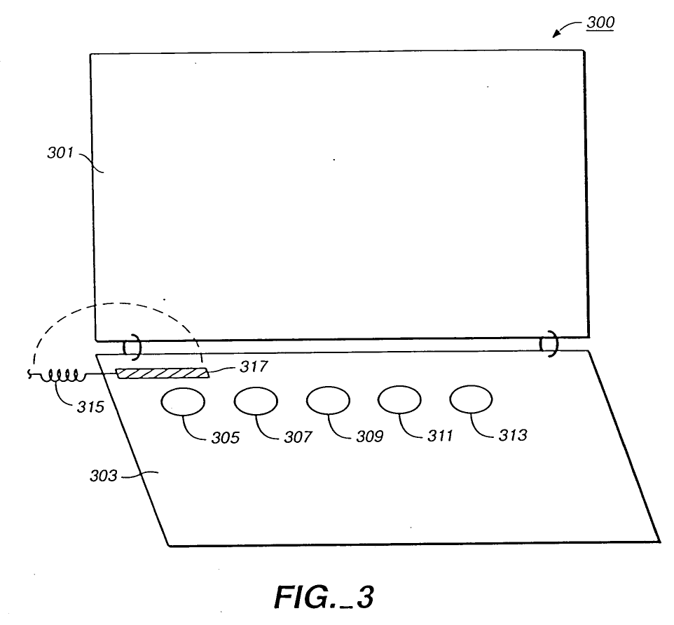

An exemplary attendee viewing device 300 is illustrated in FIG. 3 As indicated above, in the preferred embodiment the attendee viewing device would be a Java/JINI compatible device with a processor, memory, battery for power with a preferable life of 6 hours, wireless capable input/output device. The attendee viewing device 300 has a flat panel display and a control panel 303. The control panel has a wireless antenna 315 which can be folded into a holding slot 317 or alternatively could have a wireless antenna built into the case 303. The control panel contains a plurality of buttons 305, 307, 309, 311, 313. The buttons would perform the functions of turning the unit on and off; providing a method of intensity control of the screen; selecting a video image/camera; selecting among various text options; and selecting split screen viewing for viewing both a video image and text at the same time. It is contemplated that the buttons would be silent buttons so as not to perform any offensive clicking noises. Similarly the screen intensity would be controlled so as not to intrude on neighboring attendees. Only a few of the buttons would be used at any one time, but it would be useful for the central computer to know which buttons are in use so as to gather statistics on what the audience likes to see. The system could be tailored to fit different kinds of occasions, even lectures, classrooms, operas, sporting events, etc.

In the theatrical/musical performance setting, an alternative viewing device would include a pair of virtual glasses for viewing in a less obtrusive way for neighboring attendees with the glasses connected by wire to a small control box having the buttons, memory, processor, wireless receiver and JINI/Java or other plug-and-participate technology.

In the classroom setting, an alternative viewing device will have a connection to plug in a student's laptop computer, whereby text received by the viewing device (or laptop directly) can be stored for later viewing by the student attendee. Such text materials would be class notes, agenda, and other handouts from the instructor which could be received and viewed later so as not to interfere with the student's attention to the lecture itself.

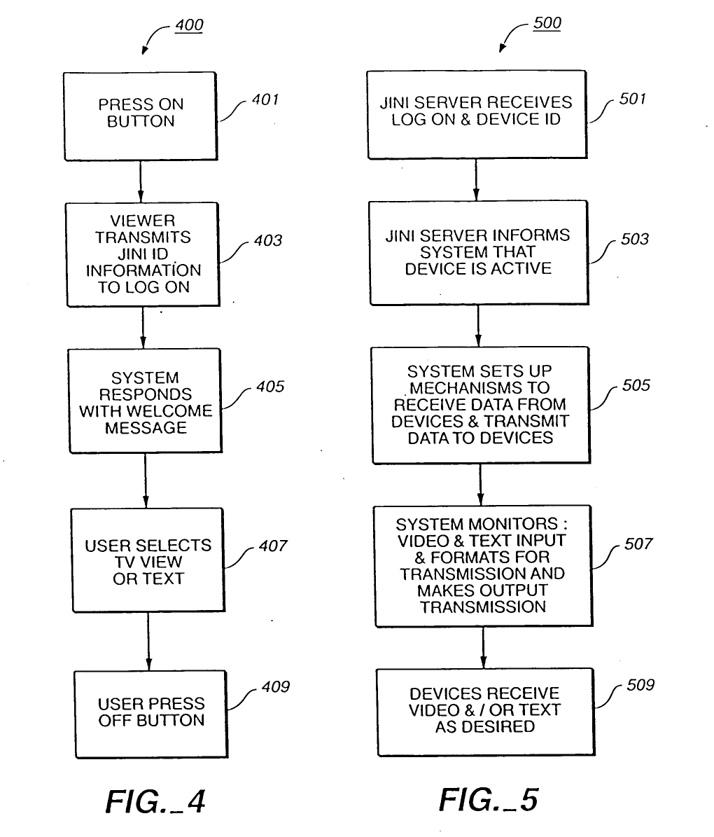

In FIG. 4 a flow chart of the process of using the attendee viewer is shown. The attendee initially presses the on/off button to turn the device on 401. This act initiates a JINI based transmission to the nearest JINI server (221 in FIG. 2) telling the server that the viewing device is actively in the system and can be accessed by the provided protocol. 403 The server informs the system control device (209 in FIG. 2) which sends a “welcome” message to the viewing device so that the attendee knows he is in the system.405 The user selects a video image/camera or text option 407 by depressing the appropriate button. When the attendee is finished using the viewing device he depresses the Off button to terminate the connection.

In FIG. 5 a flow chart is shown which indicates the operation of the system during the course of a performance/lecture.500 When a viewing device (or any other JINI compatible device or other plug-and-participate type device such as a camera, scanner, etc.) plugs into the system, the JINI server receives the log-on, device ID data and device access driver/protocol data 501 which it records and makes available to other system users (i.e. the system control unit) 503. The system control unit sets up mechanisms to receive data from the video cameras, for example) and to broadcast these data over a wireless output system 505, 507. The attendee viewing devices can then tune to receive the video image or text data using their selection buttons.509.

In an alternative embodiment, the viewer can have a mechanism for the attendee to provide a response or question to the performer/lecturer if requested to do so by them. These features are not available from a video tape and would be a reason for the attendee to want to come to a live performance enhanced by the availability of the present invention.

Having described the invention in terms of a preferred embodiment, it will be recognized by those skilled in the art that various types of general purpose computer hardware may be substituted for the configuration described above to achieve an equivalent result. Similarly, it will be appreciated that arithmetic logic circuits are configured to perform each required means in the claims for performing the various features of video image processing, text processing, wireless receipt and transmission to short range viewing devices. It will be apparent to those skilled in the art that modifications and variations of the preferred embodiment are possible, such as different types or makes or configurations of viewing devices, different makes and types of video cameras and text input devices, different wireless communications systems, all of which fall within the true spirit and scope of the invention as measured by the following claims.

1. An apparatus for viewing video, text or a combination of both in a symphonic, operatic, classroom, or other performance setting, the apparatus comprising:
a viewing device having a display, a memory, a processing unit and a control panel, the viewing device for use by an attendee; and
a control program in the memory adaptable to receive and display video images, or text data or both, the data and/or images being received from a transmission system, the transmission system operating in a performance venue to receive video and text data and retransmit the video and text data to the viewing device.

2. The apparatus of claim 1 wherein the video and text data is transmitted on different frequencies in a wireless transmission.

3. The apparatus of claim 1 wherein the processing unit in the viewing device contains an operating system and code allowing the viewing device to be a JINI compatible device.

4. A system for permitting attendees at a performance to selectively view video data or text data or both by use of a viewing device, the system comprising:
one or more video cameras for inputting video data images of performers, wherein the performers may be musicians, conductors, singers, actors, dancers, teachers or other speakers;
one or more input terminals for inputting text into the system;
a central control unit for receiving the video data and the text data, the central control unit having input/output units, memory, a processing unit and a short range transmission capability; and
one or more attendee viewing devices capable of receiving video and text transmissions from the central control unit.

5. The system of claim 4 wherein the attendee viewing devices are JINI compatible devices and the system is JINI compatible, wherein being JINI compatible means having code in the device or system conforming to the JINI protocol.

6. The system of claim 4 wherein the performance is a symphony or an opera or a ballet or a play or a classroom lecture.

7. A method for enhancing the enjoyment of attendees at a performance, the method comprising the steps of:
obtaining an attendee viewing device;
turning the attendee viewing device on to cause it to log-on to a viewing system located in a venue of the performance; and
selecting on the attendee viewing device a video image from a camera in the viewing system or selecting text provided by the viewing system, or selecting a combination of video and text for display on a split screen.

8. The method of claim 7 wherein the attendee viewing device is a JINI compatible device.

9. The method of claim 7 wherein the video and text data are transmitted from the viewing system in a wireless transmission.

10. The method of claim 8 wherein the viewing system is a JINI compatible system.

11. A system for permitting attendees at a performance to selectively view video or text or both, the system comprising: m
means for viewing video or text or both for the performance in a seat location in a venue of the performance;
means for collecting video and or text relating to the performance and for retransmitting the video or text data to nearby qualified viewing devices.

12. The system of claim 11 wherein the performance is a training or classroom lecture in one of a college, a business location, and a third venue location separate from the college or business location.
